(19) United States
(12) Patent Application Publication
(10) Pub. No.: US 2014/0333595 A1
(43) Pub. Date: Nov. 13, 2014

(54) METHOD OF DRIVING DISPLAY PANEL AND DISPLAY APPARATUS FOR PERFORMING THE SAME

(71) Applicant: Samsung Display Co., LTD., Yongin-City (KR)

(72) Inventors: Se-Hyoung CHO, Hwaseong-si (KR); Il-Gon KIM, Seoul (KR); In-Jae HWANG, Suwon-si (KR); Bong-Hyun YOU, Yongin-si (KR)

(73) Assignee: Samsung Display Co., LTD., Yongin-City (KR)

(21) Appl. No.: 13/970,054

(22) Filed: Aug. 19, 2013

(30) Foreign Application Priority Data
May 13, 2013 (KR) 10-2013-0053964

(51) Int. Cl. G09G 3/36

(52) U.S. Cl. CPC G09G 3/3614
USPC 345/209; 345/96

(57) ABSTRACT

A method of driving a display panel includes providing a switching element of a pixel of the display panel with a first polarity gate signal through a gate line connected to the switching element when the switching element receives a first polarity data signal having a first polarity with respect to a reference signal, and providing the switching element with a second polarity gate signal through the gate line when the switching element receives a second polarity data signal having a second polarity with respect to the reference signal through the data line.

This application claims priority to Korean Patent Application No. 10-2013-0053964, filed on May 13, 2013, and all the benefits accruing therefrom under 35 U.S.C. §119, the content of which in its entirety is herein incorporated by reference.

### BACKGROUND

1. Field

Exemplary embodiments of the invention relate to a method of driving a display panel and a display apparatus for performing the method. More particularly, example embodiments of the invention relate to a method of driving a display panel with improved display quality and a display apparatus for performing the method.

2. Description of the Related Art

Generally, a liquid crystal display (“LCD”) apparatus has relatively thin thickness, light weight and low power consumption, and thus the LCD apparatus is widely used in various devices, e.g., monitors, laptop computers and cellular phones. The LCD apparatus includes an LCD panel for displaying images using light transmittance of a liquid crystal, a backlight assembly disposed under the LCD panel and for providing light to the LCD panel, and a driving circuit for driving the LCD panel.

The liquid display panel typically includes an array substrate which includes a gate line, a data line, a thin film transistor and a pixel electrode, an opposing substrate which includes a common electrode, and a liquid crystal layer disposed between the array substrate and the opposing substrate. The driving circuit includes a gate driving part which drives the gate line and the data driving part which drives the data line.

In a large size liquid display panel, a resistor-capacitor (“RC”) time delay of the gate signal transferred through the gate line and the data signal transferred through the data line occurs. For example, the RC time delay of the gate signal occurs in an area far away from the gate driving part outputting the gate signal the gate driving part, and a charging ratio may be decreased by the RC time delay of the gate signal, which controls a charging period, during which the data signal is charged in the pixel so that.

### SUMMARY

Exemplary embodiments of the invention provide a method of driving a display panel with reduced data charging difference by a delay of a gate signal.

Exemplary embodiments of the invention also provide a display apparatus performing the method of driving the display panel.

According to an exemplary embodiment of the invention, a method of driving a display panel includes providing a switching element of a pixel of the display panel with a first polarity gate signal through a gate line connected to the switching element when the switching element receives a first polarity data signal having a first polarity with respect to a reference signal, and providing the switching element with a second polarity gate signal through the gate line when the switching element receives a second polarity data signal having a second polarity with respect to the reference signal through the data line.

In an exemplary embodiment, a falling timing of the first polarity gate signal in a horizontal period may be substantially the same as a falling timing of the second polarity gate signal in the horizontal period, the falling timing of the first polarity gate signal may be a start timing of a falling period, during which a level of the first polarity gate signal falls from a high level to a low level, and the falling timing of the second polarity gate signal may be a start timing of a falling period, during which a level of the second polarity gate signal falls from a high level to a low level.

In an exemplary embodiment, the first polarity gate signal may have a first gate-on level and a first gate-off level, and the second polarity gate signal may have a second gate-on level lower than the first gate-on level and a second gate-off level lower than the first gate-off level.

In an exemplary embodiment, one of a gate-on level and a gate-off level of the first polarity gate signal may be different from one of a gate-on level and a gate-off level of the second polarity gate signal.

In an exemplary embodiment, a falling timing of the first polarity gate signal in a horizontal period may be different from a falling timing of the second polarity gate signal in the horizontal period, the falling timing of the first polarity gate signal may be a start timing of a falling period, during which a level of the first polarity gate signal falls from a high level to a low level, and the falling timing of the second polarity gate signal may be a start timing of a falling period, during which a level of the second polarity gate signal falls from a high level to a low level.

In an exemplary embodiment, a gate-on level and a gate-off level of the first polarity gate signal may be substantially the same as a gate-on level and a gate-off level of the second polarity gate signal, respectively.

In an exemplary embodiment, the first polarity gate may have a first pulse width, and the second polarity gate signal has a second pulse width different from the first pulse width.

In an exemplary embodiment, the first polarity gate has a pulse width, which is substantially the same as a pulse width of the second polarity gate signal.

According to another exemplary embodiment of the invention, a display apparatus includes a display panel including a plurality of data lines, a plurality of gate lines and a plurality of pixels, where each of the pixels includes a switching element connected to a corresponding data line of the data lines and a corresponding gate line of the gate lines, a data driving part which provides the display panel with a first polarity data signal having a first polarity with respect to a reference signal and a second polarity data signal having a second polarity with respect to the reference signal, and a gate driving part which provides the switching element with a first polarity gate signal when the switching element receives the first polarity data signal, and provides the switching element with the second polarity gate signal when the switching element receives the second polarity data signal.

In an exemplary embodiment, a falling timing of the first polarity gate signal in a horizontal period may be substantially the same as a falling timing of the second polarity gate signal in the horizontal period, the falling timing of the first polarity gate signal may be a start timing of a falling period, during which a level of the first polarity gate signal falls from a high level to a low level, and the falling timing of the second polarity gate signal may be a start timing of a falling period, during which a level of the second polarity gate signal falls from a high level to a low level.

In an exemplary embodiment, the first polarity gate signal may have a first gate-on level and a first gate-off level, and the second polarity gate signal may have a second gate-on level lower than the first gate-on level and a second gate-off level lower than the first gate-off level.

In an exemplary embodiment, one of a gate-on level and a gate-off level of the first polarity gate signal may be different from one of a gate-on level and a gate-off level of the second polarity gate signal.

In an exemplary embodiment, a falling timing of the first polarity gate signal in a horizontal period may be different from a falling timing of the second polarity gate signal in the horizontal period, the falling timing of the first polarity gate signal may be a start timing of a falling period, during which a level of the first polarity gate signal falls from a high level to a low level, and the falling timing of the second polarity gate signal may be a start timing of a falling period, during which a level of the second polarity gate signal falls from a high level to a low level.

In an exemplary embodiment, the falling timing of the first polarity gate signal in a horizontal period may be later than the falling timing of the second polarity gate signal in the horizontal period.

In an exemplary embodiment, a gate-on level and a gate-off level of the first polarity gate signal may be substantially the same as a gate-on level and a gate-off level of the second polarity gate signal, respectively.

In an exemplary embodiment, the first polarity gate may have a pulse width different from a pulse width of the second polarity gate signal.

In an exemplary embodiment, the first polarity gate may have a pulse width substantially the same as a pulse width of the second polarity gate signal.

In an exemplary embodiment, the pixels of the display panel may be arranged substantially in a matrix form including a plurality of pixel columns in a first direction and a plurality of pixel rows in a second direction crossing the first direction, a gate line of the gate lines may be alternately connected to the pixels in two adjacent pixel rows, a data line of the data lines may be connected to the pixels in a same pixel column, the first polarity gate signal may be applied to an odd-numbered gate line of the gate lines, and the second polarity gate may be applied to an even-numbered gate line of the gate lines.

In an exemplary embodiment, each of the pixels may include a first sub-pixel and a second sub-pixel, the first sub-pixel may include a first switching element connected to a first data line of the data lines, which receives the first polarity data signal, and a first gate line of the gate lines, which receives the first polarity gate signal, and the second sub-pixel may include a second switching element connected to a second data line of the data lines, which receives the second polarity data signal, and a second gate line of the gate lines, which receives the second polarity gate signal.

In an exemplary embodiment, the pixels of the display panel may be arranged substantially in a matrix form including a plurality of pixel columns in a first direction and a plurality of pixel rows in a second direction crossing the first direction, a gate line of the gate liens may be alternately connected to the pixels in two adjacent pixel rows, the pixels in a same pixel column may be alternately connected to two adjacent data lines, the first polarity gate signal may be applied to an odd-numbered gate line of the gate lines, and the second polarity gate may be applied to an even-numbered gate line of the gate lines.

According to embodiments of the invention, the gate signal is dualized as the positive polarity gate signal corresponding to the positive polarity data signal and the negative polarity gate signal corresponding to the negative polarity data signal such that a data charging difference between a positive polarity data signal and a negative polarity data signal by the resistor-capacitor (“RC”) time delay is substantially reduced, and display quality is thereby substantially improved.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus;

FIG. 2 is a block diagram illustrating an exemplary embodiment of a pixel of a display panel shown in FIG. 1;

FIG. 3 is a block diagram illustrating an exemplary embodiment of a gate driving part shown in FIG. 1;

FIG. 4 is a signal timing diagram illustrating input and output signals of the gate driving part shown in FIG. 3

FIGS. 5A and 5B are waveform diagrams illustrating a data charging ratio according to a gate signal;

FIG. 6 is a block diagram illustrating an alternative exemplary embodiment of a pixel of a display panel;

FIG. 7 is a conceptual diagram illustrating another alternative exemplary embodiment of a pixel of a display panel;

FIG. 8 is a signal timing diagram illustrating input and output signals of an alternative exemplary embodiment of a gate driving part shown in FIG. 3;

FIG. 9 is a waveform diagram illustrating a data charging ratio according to the gate signal shown in FIG. 8;

FIG. 10 is a signal timing diagram illustrating input and output signals of an alternative exemplary embodiment of a gate driving part;

FIG. 11 is a waveform diagram illustrating a data charging ratio according to the gate signal shown in FIG. 10; and

FIG. 12 is a signal timing diagram illustrating input and output signals of another alternative exemplary embodiment of a gate driving part.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

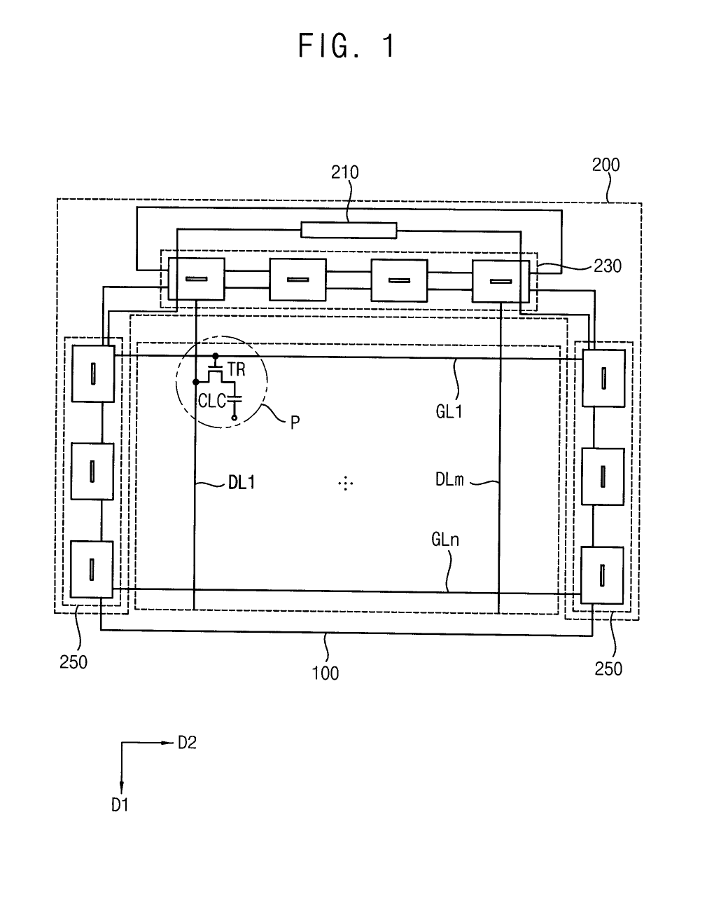

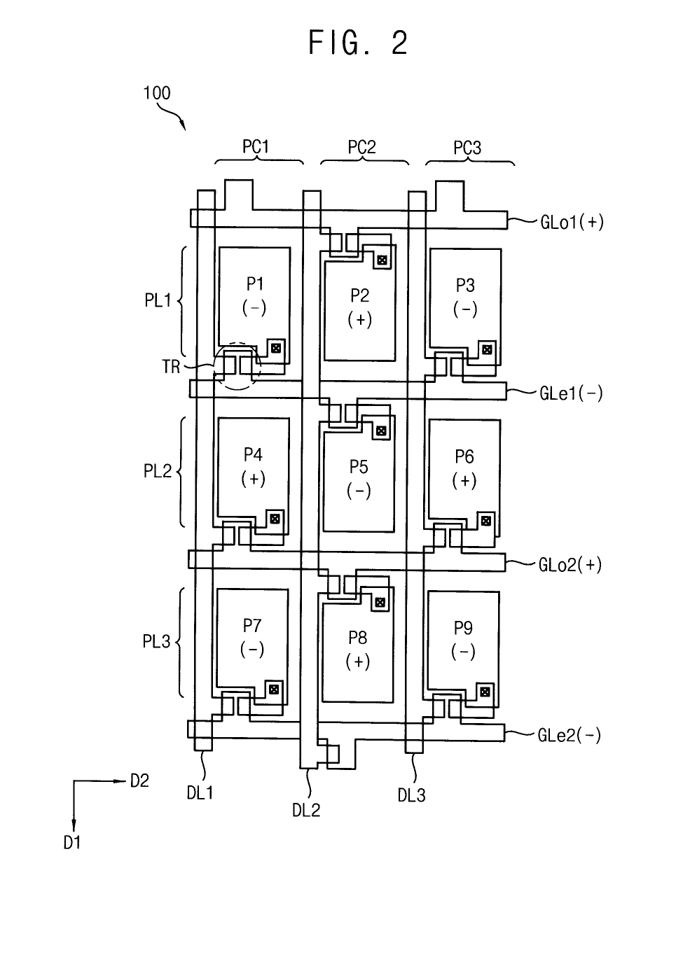

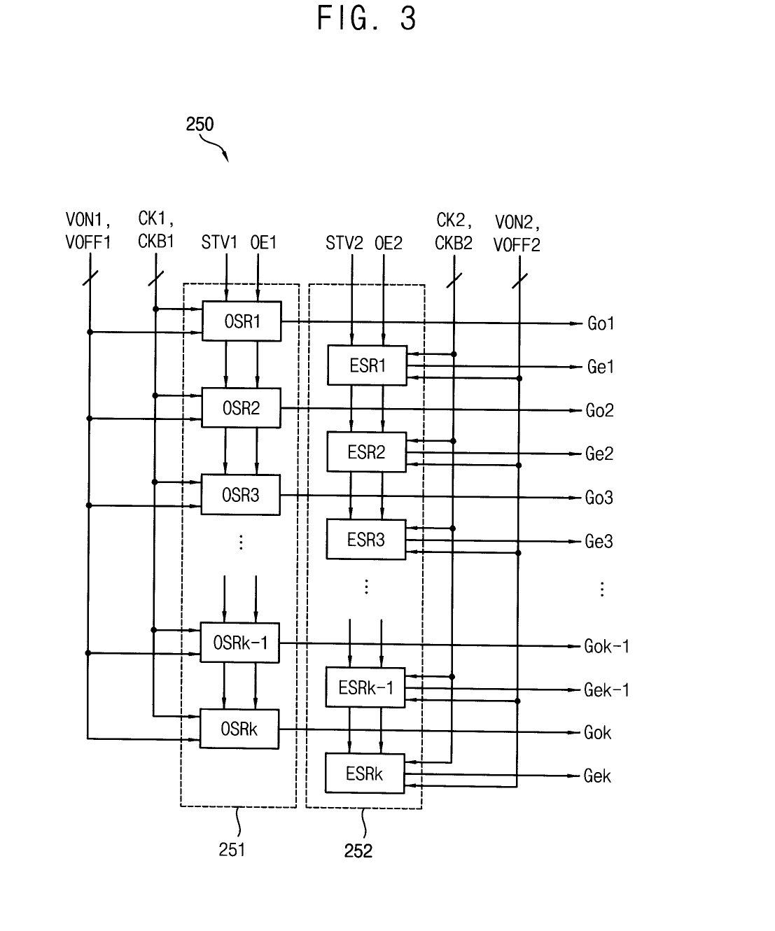

FIG. 1 is a block diagram illustrating an exemplary embodiment of a display apparatus, FIG. 2 is a block diagram illustrating an exemplary embodiment of a pixel of the display panel shown in FIG. 1, and FIG. 3 is a block diagram illustrating an exemplary embodiment of a gate driving part as shown in FIG. 1.

Referring to FIGS. 1, 2 and 3, an exemplary embodiment of the display apparatus may include a display panel 100 and a display driving part 200.

The display panel 100 may include a plurality of data lines DL1, . . . , DLm, a plurality of gate lines GL1, . . . , GLn and a plurality of pixels P. Each of the pixels P includes a switching element TR connected to a corresponding data line DL1 and a corresponding gate line GL1, and a liquid crystal capacitor CLC connected to the switching element TR.

As shown in FIG. 2, the pixels P1, P2, P3, . . . are arranged substantially in a matrix form including a plurality of pixel rows and a plurality of pixel columns. The data lines DL1, . . . , DLm extend substantially in a first direction D1, e.g., a pixel column direction, and arranged substantially in a second direction D2, e.g., a pixel row direction, crossing the first direction D1. Each of the data lines is electrically connected to the pixels of a same pixel column arranged in the first direction D1.

The gate lines GL1, . . . , GLn extend substantially in the second direction D2 and arranged substantially in the first direction D1.

Pixels of a same pixel row are alternately connected to two gate lines adjacent to each other, e.g., an odd gate line and an even gate line. In one exemplary embodiment, for example, pixels P1, P2 and P3 of a first pixel row PL1 are alternately connected to a first odd gate line GLo1 and a first even gate line GLe1. In such an embodiment, pixels of a second pixel row PL2 are alternately connected to the first even gate line GLe1 and a second odd gate line GLo2. In such an embodiment, pixels P7, P8 and P9 of a third pixel row PL3 are alternately connected to the second odd gate line GLo2 and a second even gate line GLe2. In an exemplary embodiment, as shown in FIG. 2, the pixels P1, P4 and P7 of a first pixel column PC1 are connected to a first data line DL1, the pixels P2, P5 and P8 of a second pixel column PC2 are connected to a second data line DL2, and the pixels P3, P6 and P9 of a third pixel column PC3 are connected to a third data line DL3.

The display driving part 200 may include a control circuit part 210, a data driving part 230 and a gate driving part 250. The control circuit part 210 controls operation of the data driving part 230 and the gate driving part 250. In one exemplary embodiment, for example, the control circuit part 210 provides the data driving part 230 with a data signal and a data control signal. The data signal may include a color data signal and may be a signal corrected or compensated using compensation algorithms for improving a response time of a liquid crystal and for compensating a white. The control circuit part 210 provides the gate driving part 250 with a first gate control signal, a first gate-on signal, a first gate-off signal, a second gate control signal, a second gate-on signal and a second gate-off signal, for example.

In an exemplary embodiment, the data driving part 230 provides a first polarity data signal having a first polarity with respect to a reference signal, e.g., a positive polarity data signal having a positive polarity with respect to the reference signal, and a second polarity data signal having a second polarity, which is opposite to the first polarity, with respect to a reference signal, e.g., a negative polarity data signal having a negative polarity with respect to the reference signal, to the data lines DL1, . . . , DLm according to a dot inversion mode. The data driving part 230 provides two data lines adjacent to each other with data signals having different polarities from each other. The data driving part 230 inverses a polarity of a data signal every horizontal period 1H in a frame period and every frame period. Therefore, as shown in FIG. 2, the display panel 100 is driven as a one-dot inversion mode.

As shown in FIG. 3, the gate driving part 250 includes an odd gate circuit 251 and an even gate circuit 252. The odd gate circuit 251 includes a plurality of odd shift registers OSR1, . . . , OSRk which generates a plurality of odd-numbered gate signals Go1, . . . , Gok. The odd gate circuit 251 receives the first gate control signal, a first gate-on signal VON1, a first gate-off signal VOFF1 from the control circuit part 210. The first gate control signal includes a first vertical start signal STV1, first clock signals CK1 and CKB1, a first output-enable signal OE1.

The first vertical start signal STV1 may control a start timing of an operation of the odd gate circuit 251. The first clock signals CK1 and CKB1 may control a rising timing, that is, a start timing of a rising period, during which a level of each of the odd-numbered gate signals Go1, . . . , Gok rises from a low level to a high level. The first output-enable control signal OE1 may control a falling timing, that is, a start timing of a falling period, during which a level of each of the odd-numbered gate signals Go1, . . . , Gok falls from the high level to the low level.

The first gate-on signal VON1 may control a gate-on level of each of the odd-numbered gate signals Go1, . . . , Gok, and the first gate-off signal VOFF1 may control a gate-off level of each of the odd-numbered gate signals Go1, . . . , Gok.

The even gate circuit 252 includes a plurality of even shift registers ESR1, . . . , ESRk which generates a plurality of even-numbered gate signals Ge1, . . . , Gek. The even gate circuit 252 receives the second gate control signal, a second gate-on signal VON2 and a second gate-off signal VOFF2 from the control circuit part 210. The second gate control signal includes a second vertical start signal STV2, second clock signals CK2 and CKB2 and second output-enable signal OE2.

The second vertical start signal STV2 may control a start timing of an operation of the even gate circuit 252. According to an exemplary embodiment, the second vertical start signal STV2 has a delay from the first vertical start signal STV1, for example, the delay corresponding to a horizontal period 1H. The second clock signals CK2 and CKB2 may control a rising timing, that is, a start timing of a rising period, during which a level of each of the even-numbered gate signals Ge1, . . . , Gek rises from a low level to a high level. The second output-enable control signal OE2 may control a falling timing, that is, a start timing of a falling period, during which a level of each of the even-numbered gate signals Ge1, . . . , Gek falls from the high level to the low level.

The second gate-on signal VON2 may control a gate-on level of each of the even-numbered gate signals Ge1, . . . , Gek, and the second gate-off signal VOFF2 may control a gate-off level of each of the even-numbered gate signals Ge1, . . . , Gek.

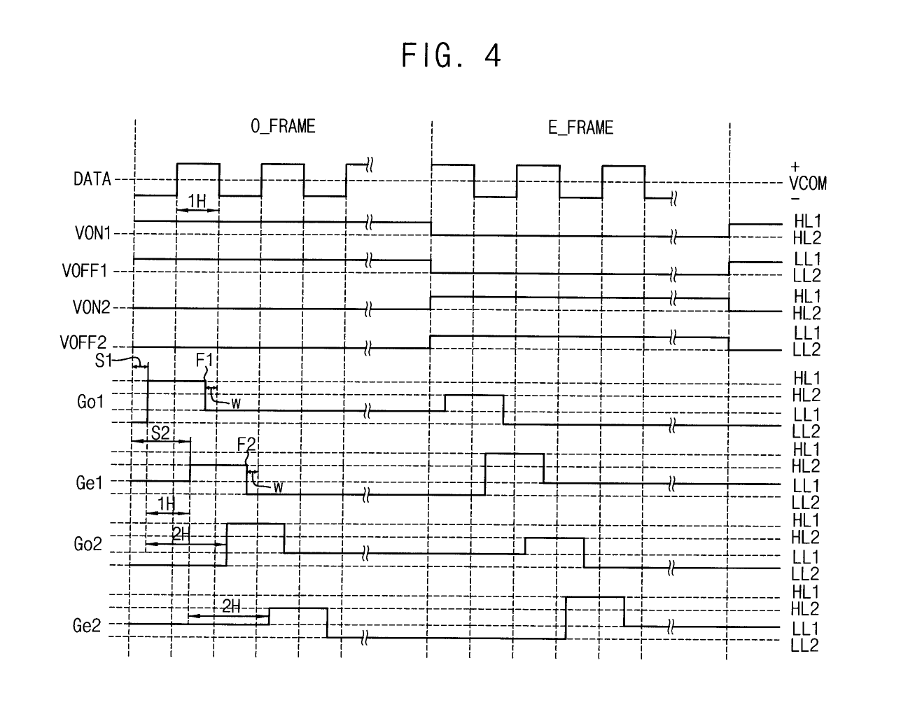

FIG. 4 is a signal timing diagram illustrating input and output signals of the gate driving part shown in FIG. 3.

Referring to FIGS. 2, 3 and 4, the data driving part outputs the data signal DATA which is inversed every the horizontal period 1H in a frame period and every frame period. In such an embodiment, the gate driving part 250 may operate in synchronization with the polarity of the data signal DATA.

Hereinafter, an exemplary embodiment of a method of driving the display panel based on the one-dot inversion mode as shown in FIG. 2 will now be described in detail. In such an embodiment, the positive polarity data signals (+) having a positive polarity with respect to the reference signal VCOM are applied to the pixels connected to the odd-numbered gate lines GLo1, GLo2, . . . , during an odd-numbered frame period (O_FRAME).

In an exemplary embodiment, the first gate-on signal VON1 repetitively swings between a first high level HL1 and a second high level HL2, which is lower than the first high level HL1, every frame period. As shown in FIG. 4, the first gate-on signal VON1 may have the first high level HL1 during the odd-numbered frame period (O_FRAME) and have the second high level HL2 during an even-numbered frame period (E_FRAME). In such an embodiment, the first gate-off signal VOFF1 repetitively swings between a first low level LL1 and a second low level LL2, which is lower than the low level LL1, every frame period. As shown in FIG. 4, the first gate-off signal VOFF1 may have the first low level LL1 during the odd-numbered frame period (O_FRAME) and have the second low level LL2 during the even-numbered frame period (E_FRAME).

In an exemplary embodiment, the second gate-on signal VON2 repetitively swings every frame period, inversely with respect to the first gate-on signal VON1. As shown in FIG. 4, the second gate-on signal VON2 may have the second high level HL2 during the odd-numbered frame period (O_FRAME) and have the first high level HL1 during the even-numbered frame period (E_FRAME). In such an embodiment, the second gate-off signal VOFF2 repetitively swings every frame period, inversely with respect to the first gate-off signal VOFF1. As shown in FIG. 4, the second gate-off signal VOFF2 may have the second low level LL2 during the odd-numbered frame period (O_FRAME) and have the first low level LL1 during the even-numbered frame period (E_FRAME).

The odd gate circuit 251 generates the odd-numbered gate signals Go1, Go2, . . . which has the gate-on level corresponding to the first high level HL1 and the gate-off level corresponding to the first low level LL1, using the first gate-on signal VON1 having the first high level HL 1 and the first gate-off signal VOFF1 having the first low level LL1. The odd-numbered gate signals Go1, Go2, . . . are sequentially applied to the odd-numbered gate lines GLo1, GLo2, . . . with an interval of two horizontal periods 2H. In such an embodiment, each of the odd-numbered gate signals Go1, Go2, . . . has a falling timing F1 which is determined by a control period W of the first output-enable control signal OE1. The falling timing is a start timing of a falling period, during which each of the odd-numbered gate signals Go1, Go2, . . . falls from the first high level HL1 to the first low level LL1.

During the odd-numbered frame period (O_FRAME), each of the odd-numbered gate signals Go1, Go2, . . . has the gate-on level corresponding to the first high level HL1 and the gate-off level corresponding to the first low level LL1.

In such an embodiment, the negative polarity data signals (−) having a negative polarity with respect to the reference signal VCOM are applied to the pixels connected to the even-numbered gate lines GLe1, GLe2, . . . , during the odd-numbered frame period (O_FRAME). The even gate circuit 252 generates the even-numbered gate signals Ge1, Ge2, . . . which have the gate-on level corresponding to the second high level HL2 and the gate-off level corresponding to the second low level LL2, using the second gate-on signal VON2 having the second high level HL2, which is lower than the first high level HL1, and the second gate-off signal VOFF2 having a second low level LL2, which is lower than the first low level LL1. The even-numbered gate signals Ge1, Ge2, . . . are sequentially applied to the even-numbered gate lines GLe1, GLe2, . . . with an interval of two horizontal periods 2H. The even-numbered gate signals Ge1, Ge2, . . . has the falling timing F2 which is determined by a control period of the second output-enable control signal OE2. The falling timing is a start timing of a falling period, during which each of the even-numbered gate signals Ge1, Ge2, . . . falls from the second high level HL2 to the second low level LL2. According to an exemplary embodiment, the second output-enable control signal OE2 may have the control period substantially the same as the control period of the first output-enable control signal OE1.

During the odd-numbered frame period O_FRAME, each of the even-numbered gate signals Ge1, Ge2, . . . has the gate-on level corresponding to the second high level HL2 and the gate-off level corresponding to the second low level LL2.

Then, the negative polarity data signal (−) are applied to the pixels connected to the odd-numbered gate lines GLo1, GLo2, . . . , during the even-numbered frame period (E_FRAME). The odd gate circuit 251 generates the odd-numbered gate signals Go1, Go2, . . . which have the gate-on level corresponding to the second high level HL2 and the gate-off level corresponding to the second low level LL2, using the second gate-on signal VON2 having the second high level HL2, which is lower than the first high level HL1, and the second gate-off signal VOFF2 having a second low level LL2, which is lower than the first low level LL1. The odd-numbered gate signals Go1, Go2, . . . are sequentially applied to the odd-numbered gate lines GLo1, GLo2, . . . with an interval of two horizontal periods 2H.

In such an embodiment, the positive polarity data signals (+) are applied to the pixels connected to the even-numbered gate lines GLe1, GLe2, . . . , during the even-numbered frame period E_FRAME. The even gate circuit 252 generates the even-numbered gate signals Ge1, Ge2, . . . which has the gate-on level corresponding to the first high level HL 1 and the gate-off level corresponding to the first low level LL1, using the first gate-on signal VON1 having the first high level HL1 and the first gate-off signal VOFF1 having the first low level LL1. The even-numbered gate signals Ge1, Ge2, . . . are sequentially applied to the even-numbered gate lines GLe1, GLe2, . . . with an interval of two horizontal periods 2H.

In an exemplary embodiment, as described above, a positive polarity gate signal is applied to the pixels which receive the positive polarity data signal (+), and the positive polarity gate signal has the gate-on level corresponding to the first high level HL1 and the gate-off level corresponding to the first low level LL1. The negative polarity gate signal is applied to the pixels which receive the negative polarity data signal (−), and the negative polarity gate signal has the gate-on level corresponding to the second high level HL2 and the gate-off level corresponding to the second low level LL2.

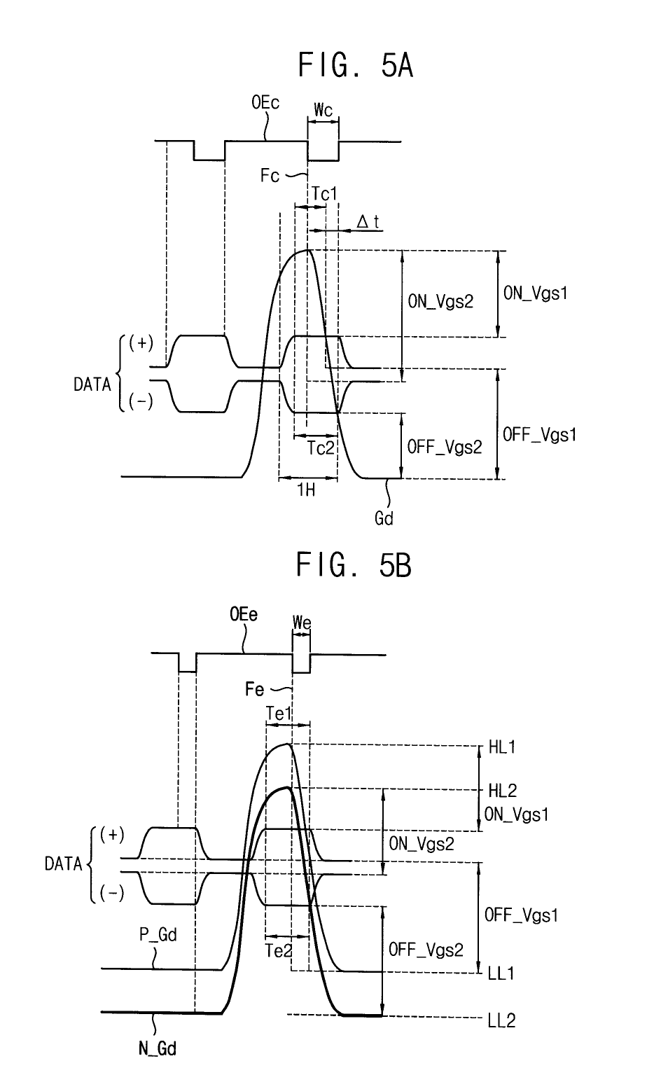

FIGS. 5A and 5B are waveform diagrams illustrating a data charging ratio according to a gate signal shown in FIG. 3.

FIG. 5A is a waveform diagram illustrating a data charging ratio by a gate signal of a comparative embodiment. FIG. 5B is a waveform diagram illustrating a data charging ratio by a gate signal of an exemplary embodiment.

The output-enable control signal may control the falling timing of the gate signal to effectively prevent the data signals applied to adjacent pixel rows from being mixed together. The resistor-capacitor (“RC”) time delay of the gate signal increases in an area far away from the gate driving part. In an exemplary embodiment, where the gate driving parts are disposed adjacent to opposite ends of the gate line, e.g., an embodiment having a dual-bank structure, the RC time delay of the gate signal may become greatest in a center portion of the display panel in a horizontal direction. Therefore, in such an embodiment, the output-enable control signal may be controlled based on a delay condition at the center portion, in which the RC time delay of the gate signal is the greatest.

Referring to FIG. 5A, in a comparative embodiment, the output-enable control signal OEc has a control period Wc which controls a falling timing Fc of a gate signal Gd thereof. The control period Wc may be determined based on the negative polarity data signal (−) to effectively prevent the data signals of adjacent pixel rows from mixing,

In a comparative embodiment, the positive polarity data signal (+) has a first charging time Tc1 and the negative polarity data signal (−) has a second charging time Tc2, by the gate signal Gd having the falling timing which is determined by the control period We of the output-enable control signal OEc. The second charging time Tc2 may be longer than the first charging time Tc1 by a time period Δt.

Accordingly, in a comparative embodiment, a gate/source voltage ON_Vgs1 of the positive polarity (+) is less than a gate/source voltage ON_Vgs2 of the negative polarity (−). When the gate/source voltage Vgs is increased, an output current of the transistor is increased. Thus, a data charging ratio of the negative polarity data signal (−) is greater than a data charging ratio of the positive polarity data signal (+). As described above, a charging difference between the positive polarity data signal (+) and the negative polarity data signal (−) may cause a lower-quality display, such as a flick and an after-image, for example.

In a comparative embodiment, the gate/source voltage OFF_Vgs1 of the positive polarity (+) may be different from the gate/source voltage OFF_Vgs2 of the negative polarity (−) such that a turn-off period of the positive polarity (+) is different from a turn-off period of the negative polarity (−), in a voltage-current curve of a transistor. Therefore, an off-leakage current of the positive polarity (+) is different from an off-leakage current of the negative polarity (−), such that an off-leakage current difference causes a lower-quality display such as a flick and an after-image, for example.

Referring to FIG. 5B, according to an exemplary embodiment, the gate signal includes a positive polarity gate signal P_Gd corresponding to the positive polarity data signal (+) and a negative polarity gate signal N_Gd corresponding to the negative polarity data signal (−). The positive polarity gate signal P_Gd has the gate-on level of the first high level HL1 and the gate-off level of the first low level LL1. The negative polarity gate signal N_Gd has the gate-on level of the second high level HL2, which is lower than the first high level HL1, and the gate-off level of the second low level LL2, which is lower than the first low level LL1.

A voltage difference between the gate-on and gate-off levels of the positive polarity gate signal P_Gd is substantially the same as a voltage difference between the gate-on and gate-off levels of the negative polarity gate signal N_Gd.

According to an exemplary embodiment, the gate signal includes a dualized gate signals, e.g., the positive polarity gate signal and the negative polarity gate signal, such that the gate/source voltage of the positive polarity (+) becomes substantially the same as the gate/source voltage of the negative polarity (−). In such an embodiment, as shown in FIG. 5B, the gate/source voltage ON_Vgs1 of the positive polarity (+) is substantially the same as the gate/source voltage ON_Vgs2 of the negative polarity (−). Thus, the charging difference between the positive polarity data signal (+) and the negative polarity data signal (−) may be substantially reduced. In such an embodiment, in the voltage-current curve of a transistor, the turn-off period of the positive polarity data signal (+) is substantially the same as the turn-off period of the negative polarity data signal (−). Therefore, the off-leakage current difference of the positive polarity data signal (+) and the negative polarity data signal (−) may be decreased.

In an exemplary embodiment, each of the gate-on and gate-off levels are dualized for the positive polarity data signal (+) and the negative polarity data signal (−). Thus, the control period We of the output-enable control signal OEe corresponding to the positive polarity data signal (+) may be set to be substantially the same as the control period We of the output-enable control signal OEe corresponding to the negative polarity data signal (−). In an exemplary embodiment, the control period We of the output-enable control signal OEe may be less than the control period We of the output-enable control signal OEc of the comparative embodiment shown in FIG. 5A.

Therefore, in an exemplary embodiment, the gate-on and gate-off levels are dualized for the positive polarity data signal (+) and the negative polarity data signal (−) such that differences of the charging ratio and the off-leakage current are substantially reduced, and the display quality is thereby substantially improved.

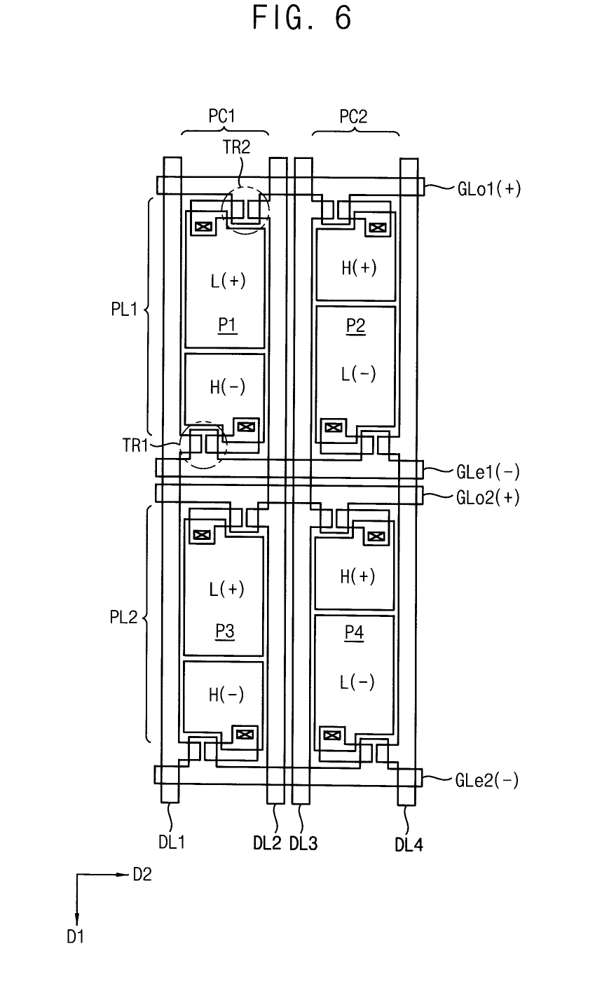

FIG. 6 is a block diagram illustrating an alternative exemplary embodiment of a pixel of a display panel.

Referring to FIG. 6, according to an exemplary embodiment, the display panel includes a plurality of data lines DL1, DL2, DL3 and DL4, a plurality of gate lines GLo1, GLo2, GLe1 and GLe2 and a plurality of pixels P1, P2, P3 and P4. The pixels P1, P2, P3 and P4 are arranged substantially in a matrix form including a plurality of pixel rows and a plurality of pixel columns.

In one exemplary embodiment, for example, a first pixel row PL1 includes a first pixel P1 and a second pixel P2. In such an embodiment, a second pixel row PL2 includes a third pixel P3 and a fourth pixel P4, a first pixel column PC1 includes the first pixel P1 and the third pixel P3, and a second pixel column PC2 includes the second pixel P2 and the fourth pixel P4.

Each of the pixels P1, P2, P3 and P4 includes a first sub-pixel H (high sub-pixel) and a second sub-pixel L (low sub-pixel) arranged substantially in the first direction D1. In one exemplary embodiment, for example, the high sub-pixel H of the first pixel P1 includes a first switching element TR1 which is connected to a first data line DL1 and a first gate line GLe1, and the low sub-pixel L of the first pixel P1 includes a second switching element TR2 which is connected to a second data line DL2 and a second gate line GLo1. In such an embodiment, the low sub-pixel L may have a size larger than a size of the high sub-pixel H. The high sub-pixel H of each pixel is adjacent to the low sub-pixel L of a neighboring pixel.

In such an embodiment, as shown in FIG. 6, a first odd gate line GLo1 is electrically connected to the low sub-pixel L of the first pixel P1 and the high sub-pixel H of the second pixel P2. A first even gate line GLe1 is electrically connected to the high sub-pixel H of the first pixel P1 and the low sub-pixel L of the second pixel P2. A second odd gate line GLo2 is electrically connected to the low sub-pixel L of the third pixel P3 and the high sub-pixel H of the fourth pixel P4. A second even gate line GLe2 is electrically connected to the high sub-pixel H of the third pixel P3 and the low sub-pixel L of the second pixel P4.

In such an embodiment, a first data line DL1 is electrically connected to the high sub-pixel H of the first pixel P1 and the high sub-pixel H of the third pixel P3. A second data line DL2 is electrically connected to the low sub-pixel L of the first pixel P1 and the low sub-pixel L of the third pixel P3. A third data line DL3 is electrically connected to the high sub-pixel H of the second pixel P1 and the high sub-pixel H of the fourth pixel P3. A fourth data line DL4 is electrically connected to the low sub-pixel L of the second pixel P1 and the low sub-pixel L of the fourth pixel P3.

Referring to FIGS. 2 and 6, the display panel is driven based on an inversion mode, such that the high sub-pixel H and the low sub-pixel L of a same pixel respectively charge data signals having different polarities from each other.

Referring to FIGS. 3, 4 and 6, in an exemplary embodiment, the positive polarity data signals (+) having a positive polarity with respect to a reference signal VCOM are applied to the high and low sub-pixels H and L, which are connected to the odd-numbered gate lines GLo1, GLo2, . . . , during an odd-numbered frame period (O_FRAME). The odd gate circuit 251 generates the odd-numbered gate signals Go1, Go2, . . . , which has the gate-on level corresponding to the first high level HL1 and the gate-off level corresponding to the first low level LL1, using the first gate-on signal VON1 having the first high level HL1 and the first gate-off signal VOFF1 having the first low level LL1. The odd-numbered gate signals Go1, Go2, . . . are sequentially applied to the odd-numbered gate lines GLo1, GLo2, . . . with an interval of two horizontal periods 2H. Each of the odd-numbered gate signals Go1, Go2, . . . is a positive polarity gate signal which has the gate-on level corresponding to the first high level HL1 and the gate-off level corresponding to the first low level LL1.

However, the negative polarity data signals (−) having a negative polarity with respect to the reference signal VCOM are applied to the high and low sub-pixels connected to the even-numbered gate lines GLe1, GLe2, . . . , during the odd-numbered frame period (O_FRAME). The even gate circuit 252 generates the even-numbered gate signals Ge1, Ge2, . . . which have the gate-on level corresponding to the second high level HL2 and the gate-off level corresponding to the second low level LL2, using the second gate-on signal VON2 having the second high level HL2, which is lower than the first high level HL1 and the second gate-off signal VOFF2 having a second low level LL2, which is lower than the first low level LL1. The even-numbered gate signals Ge1, Ge2, . . . are sequentially applied to the even-numbered gate lines GLe1, GLe2, . . . with an interval of two horizontal periods 2H. Each of the even-numbered gate signals Ge1, Ge2, . . . is a negative polarity gate signal which has the gate-on level corresponding to the second high level HL2 and the gate-off level corresponding to the second low level LL2.

Then, the negative polarity data signals (−) having a negative polarity with respect to the reference signal VCOM are applied to the high and low sub-pixels connected to the odd-numbered gate lines GLo1, GLo2, . . . , during the even-numbered frame period (E_FRAME). The odd gate circuit 251 generates the odd-numbered gate signals Go1, Go2, . . . which have the gate-on level corresponding to the second high level HL2 and the gate-off level corresponding to the second low level LL2, using the second gate-on signal VON2 having the second high level HL2, which is lower than the first high level HL1 and the second gate-off signal VOFF2 having the second low level LL2, which is lower than the first low level LL1. The odd-numbered gate signals Go1, Go2, . . . are sequentially applied to the odd-numbered gate lines GLo1, GLo2, . . . with an interval of two horizontal periods 2H. Each of the odd-numbered gate signals Go1, Go2, . . . is the negative polarity gate signal, which has the gate-on level corresponding to the second high level HL2 and the gate-off level corresponding to the second low level LL2.

In such an embodiment, the positive polarity data signals (+) having a positive polarity with respect to a reference signal VCOM are applied to the high and low sub-pixels H and L, which are connected to the even-numbered gate lines GLe1, GLe2, . . . , during the even-numbered frame period (E_FRAME). The even gate circuit 252 generates the even-numbered gate signals Ge1, Ge2, . . . , which has the gate-on level corresponding to the first high level HL1 and the gate-off level corresponding to the first low level LL1, using the first gate-on signal VON1 having the first high level HL1 and the first gate-off signal VOFF1 having the first low level LL1. The even-numbered gate signals Ge1, Ge2, . . . are sequentially applied to the even-numbered gate lines GLe1, GLe2, . . . with an interval of two horizontal periods 2H. Each of the even-numbered gate signals Ge1, Ge2, . . . is the positive polarity gate signal, which has the gate-on level corresponding to the first high level HL1 and the gate-off level corresponding to the first low level LL1.

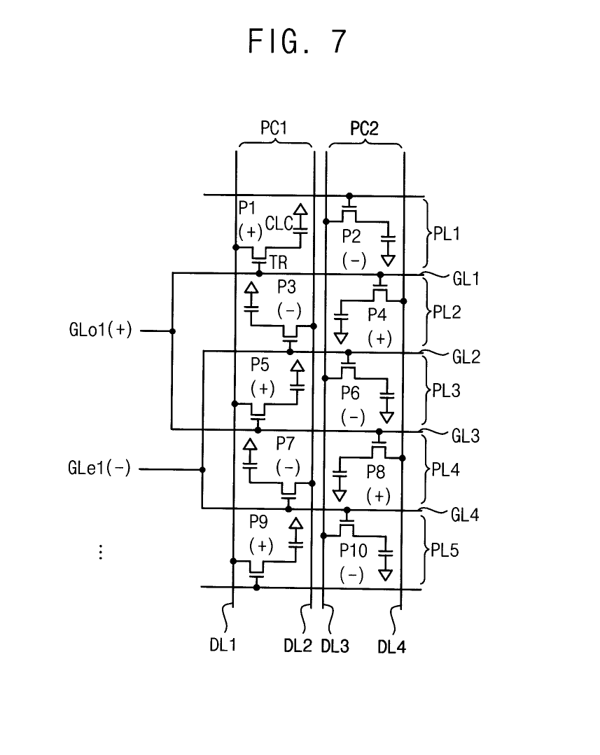

FIG. 7 is a conceptual diagram illustrating an exemplary embodiment of a pixel of a display panel.

Referring to FIG. 7, according to an exemplary embodiment, the display panel includes a plurality of data lines DL1, DL2, DL3, DL4, . . . a plurality of gate lines GL1, GL2, GL3, GL4, . . . and a plurality of pixels P1, P2, P3, . . . , P10. The pixels P1, P2, P3, . . . , P10 are arranged substantially in a matrix form including a plurality of pixel rows and a plurality of pixel columns. In such an embodiment, a gate line is alternately connected to pixels of two adjacent pixel rows, and pixels of a same pixel column are alternately connected to two adjacent data lines.

In an exemplary embodiment, as shown in FIG. 7, a first pixel row PL1 includes a first pixel P1 and a second pixel P2, a second pixel row PL2 include a third pixel P3 and a fourth pixel P4, a third pixel row PL3 includes a fifth pixel P5 and a sixth pixel P6, a fourth pixel row PL4 includes a seventh pixel P7 and an eighth pixel P8, a fifth pixel row PL5 includes a ninth pixel P9 and tenth pixel P10. In such an embodiment, a first pixel column PC1 includes the first, third, fifth and seventh pixels P1, P3, P5, P7 and P7 and a second pixel column PC2 includes the second, fourth, sixth, eighth and tenth pixels P2, P4, P6, P8 and P10.

A first gate line GL1 and a third gate line GL3 are connected to each other through an odd gate line GLo1. A second gate line GL2 and a fourth gate line GL4 are connected to each other through an even gate line GLe1.

In an exemplary embodiment, the first gate line GL1 is electrically connected to the first and fourth pixels P1 and P4 and the third gate line GL3 is electrically connected to the fifth and eighth pixels P5 and P8. In such an embodiment, the first, fourth, fifth and eighth pixels P1, P4, P5 and P8 receive an odd-numbered gate signal through the odd gate line GLo1.

In an exemplary embodiment, the second gate line GL2 is electrically connected to the third and sixth pixels P3 and P6 and the fourth gate line GL4 is electrically connected to the seventh and tenth pixels P7 and P10. In such an embodiment, the third, sixth, seventh and tenth pixels P3, P6, P7 and P10 are receive an even-numbered gate signal through the even gate line GLe1.

A first data line DL1 is electrically connected to the first, fifth and ninth pixels P1, P5 and P9, a second data line DL2 is electrically connected to the third and seventh pixels P3 and P7, a third data line DL3 is electrically connected to the second, sixth and tenth pixels P2, P6 and P10, and a fourth data line DL4 is electrically connected to the fourth and eighth pixels P4 and P8.

Referring to FIGS. 3, 4 and 7, in an exemplary embodiment, a positive polarity data signals (+) having a positive polarity with respect to a reference signal VCOM are applied to the first, fourth, fifth and eighth pixels P1, P4, P5 and P8, which are connected to the odd-numbered gate line GLo1, during an odd-numbered frame period (O_FRAME). The odd gate circuit 251 generates the odd-numbered gate signal Go1 using the first gate-on signal VON1 having the first high level HL1 and the first gate-off signal VOFF1 having the first low level LL1. The odd-numbered gate signal Go1 is applied to the odd-numbered gate line GLo1. The odd-numbered gate signal Go1 is a positive polarity gate signal, which has the gate-on level corresponding to the first high level HL1 and the gate-off level corresponding to the first low level LL1.

In such an embodiment, a negative polarity data signal (−) having a negative polarity with respect to a reference signal VCOM are applied to the third, sixth, seventh and tenth pixels P3, P6, P7 and P10, which are connected to the even-numbered gate line GLe1, during the odd-numbered frame period (O_FRAME). The even gate circuit 252 generates the even-numbered gate signal Ge1 using the second gate-on signal VON2 having the second high level HL2, which is lower than the first high level HL1, and the second gate-off signal VOFF2 having a second low level LL2, which is lower than the first low level LL1. The even-numbered gate signal Ge1 is applied to the even-numbered gate line GLe1. The even-numbered gate signal Ge1 is a negative polarity gate signal which has the gate-on level corresponding to the second high level HL2 and the gate-off level corresponding to the second low level LL2.

In such an embodiment, during the even-numbered frame period (E_FRAME), the negative polarity data signals (−) are applied to the first, fourth, fifth and eighth pixels P1, P4, P5 and P8, which are connected to the odd-numbered gate line GLo1. The odd gate circuit 251 generates the odd-numbered gate signal Go1 using the second gate-on signal VON2 having the second high level HL2, which is lower than the first high level HL1, and the second gate-off signal VOFF2 having a second low level LL2, which is lower than the first low level LL1. The odd-numbered gate signal Go1 is applied to the odd-numbered gate line GLo1. The odd-numbered gate signal Go1 is the negative polarity gate signal which has the gate-on level corresponding to the second high level HL2 and the gate-off level corresponding to the second low level LL2.

In such an embodiment, during the even-numbered frame period (E_FRAME), the positive polarity data signals (+) are applied to the third, sixth, seventh and tenth pixels P3, P6, P7 and P10, which are connected to the even-numbered gate line GLe1. The even gate circuit 252 generates the even-numbered gate signal Ge1 using the first gate-on signal VON1 having the first high level HL1 and the first gate-off signal VOFF1 having the first low level LL1. The even-numbered gate signal Ge1 is applied to the even-numbered gate signal Ge1. The even-numbered gate signal Ge1 is a positive polarity gate signal which has the gate-on level corresponding to the first high level HL1 and the gate-off level corresponding to the first low level LL1.

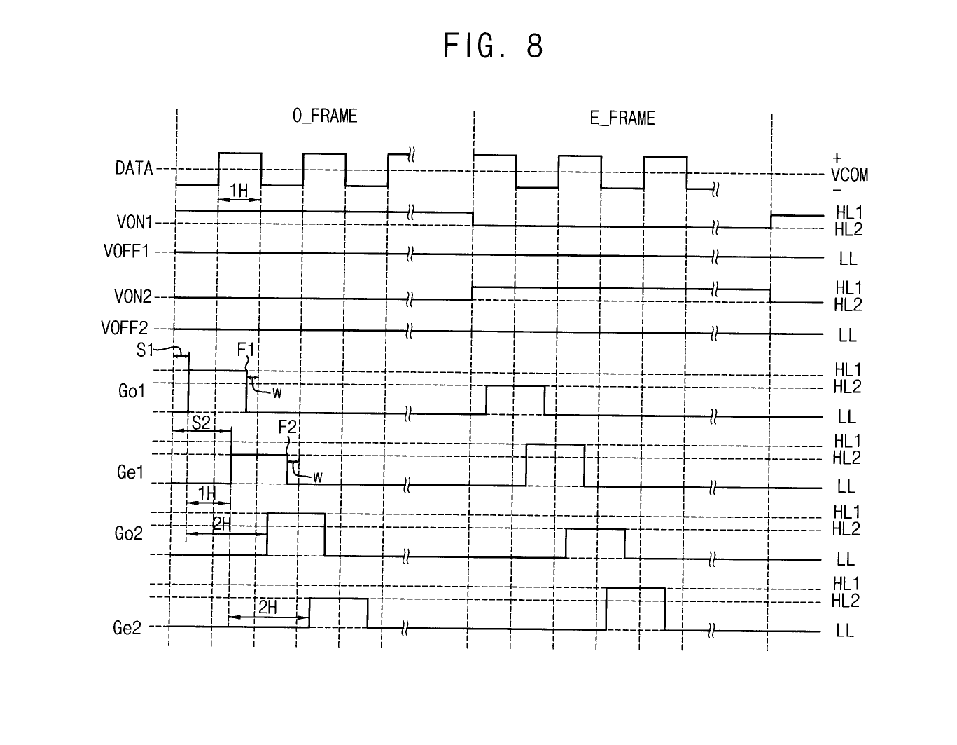

FIG. 8 is a signal timing diagram illustrating input and output signals of an alternative exemplary embodiment of a gate driving part shown in FIG. 3. The same or like elements shown in FIGS. 3 and 8 have been labeled with the same reference characters as used above to describe the exemplary embodiments shown in FIGS. 3 and 4, and any repetitive detailed description thereof will hereinafter be omitted or simplified.

Referring to FIGS. 3 and 8, according to an exemplary embodiment, the gate driving part 250 includes an odd gate circuit 251 which generates a plurality of odd-numbered gate signals Go1, . . . , Gok and an even gate circuit 252 generates a plurality of even-numbered gate signals Ge1, . . . , Gek.

The odd gate circuit 251 receives the first gate control signal, the first gate-on signal VON1, the first gate-off signal VOFF1 from the control circuit part 210. The first gate control signal includes a first vertical start signal STV1, a first clock signals CK1 and CKB1, and a first output-enable signal OE1.

The first vertical start signal STV1 may control a start timing of an operation of the odd gate circuit 251. The odd gate circuit 251 starts the operation at a first period S1 in response to the first vertical start signal STV1, and sequentially outputs the odd-numbered gate signals Go1, . . . , Gok every two horizontal periods (2H). The first clock signals CK1 and CKB1 may control a rising timing, that is, a start timing of a rising period, during which a level of each of the odd-numbered gate signals Go1, . . . , Gok rises from a low level to a high level. The first output-enable control signal OE1 may control a falling timing, that is, a start timing of a falling period, during which a level of each of the odd-numbered gate signals Go1, . . . , Gok falls from the high level to the low level.

The first gate-on signal VON1 may control a gate-on level of the odd-numbered gate signals Go1, . . . , Gok, and the first gate-off signal VOFF1 may control a gate-off level of the odd-numbered gate signals Go1, . . . , Gok.

The first gate-on signal VON1 repetitively swings between a first high level HL1 and a second high level HL2, which is lower than the first high level HL1, every frame period. As shown in FIG. 8, the first gate-on signal VON1 may have the first high level HL1 during the odd-numbered frame period (O_FRAME), and have the second high level HL2 during an even-numbered frame period (E_FRAME). The first gate-off signal VOFF1 is a direct current signal having a low level LL.

The even gate circuit 252 receives the second gate control signal, a second gate-on signal VON2 and a second gate-off signal VOFF2 from the control circuit part 210. The second gate control signal includes a second vertical start signal STV2, second clock signals CK2 and CKB2, and second output-enable signal OE2.

The second vertical start signal STV2 may control a start timing of an operation of the even gate circuit 252. The even gate circuit 252 starts the operation at a second period S2 in response to the second vertical start signal STV2, and sequentially outputs the even-numbered gate signals Ge1, . . . , Gek with an interval of two horizontal periods (2H). The second vertical start signal STV2 has a delay from the first vertical start signal STV1 by one horizontal period (1H). The second clock signals CK2 and CKB2 may control a rising timing, that is, a start timing of a rising period, during which a level of each of the even-numbered gate signals Ge1, . . . , Gek rises from a low level to a high level. The second output-enable control signal OE2 may control a falling timing, that is, a start timing of a falling period, during which a level of each of the even-numbered gate signals Ge1, . . . , Gek falls from the high level to the low level.

According to an exemplary embodiment, the second output-enable control signal OE2 is substantially the same as the first output-enable control signal OE1. Therefore, in the horizontal period 1H, the falling timing of each of the even-numbered gate signals Ge1, . . . , Gek is substantially the same as the falling timing of each of the odd-numbered gate signals Go1, . . . , Gok, as shown in FIG. 8.

The second gate-on signal VON2 may control a gate-on level of the even-numbered gate signals Ge1, . . . , Gek, and the second gate-off signal VOFF2 may control a gate-off level of the even-numbered gate signals Ge1, . . . , Gek.

The second gate-on signal VON2 repetitively swings every frame period, inversely with respect to the first gate-on signal VON1. As shown in FIG. 8, the second gate-on signal VON2 may have the second high level HL2 during the odd-numbered frame period (O_FRAME) and have the first high level RL1 during the even-numbered frame period (E_FRAME). The second gate-off signal VOFF2 is the direct current signal having the low level LL as the first gate-off signal VOFF1.

In an exemplary embodiment, an exemplary embodiment of a method of driving the display panel, where the inversion mode is the one-dot inversion mode as shown in FIG. 2, will now be described in detail. In an exemplary embodiment, the positive polarity data signals (+) having a positive polarity with respect to the reference signal VCOM are applied to the pixels connected to the odd-numbered gate lines GLo1, GLo2, . . . , during the odd-numbered frame period (O_FRAME). During the odd-numbered frame period (O_FRAME), the odd gate circuit 251 generates the odd-numbered gate signals Go1, Go2, . . . using the first gate-on signal VON1 having the first high level HL1 and the first gate-off signal VOFF1 having the low level LL, and sequentially outputs the odd-numbered gate signals Go1, Go2, . . . to the odd-numbered gate lines GLo1, GLo2, . . . , during the odd-numbered frame period (O_FRAME). During the odd-numbered frame period (O_FRAME), each of the odd-numbered gate signals Go1, Go2, . . . is a positive polarity gate signal, which has the gate-on level corresponding to the first high level HL1 and the gate-off level corresponding to the low level LL.

In such an embodiment, the negative polarity data signals (−) having a negative polarity with respect to the reference signal VCOM are applied to the pixels connected to the even-numbered gate lines GLe1, GLe2, . . . , during the odd-numbered frame period (O_FRAME). The even gate circuit 252 generates the even-numbered gate signals Ge1, Ge2, . . . using the second gate-on signal VON2 having the second high level HL2, which is lower than the first high level HL1, and the second gate-off signal VOFF2 having the low level LL, and outputs sequentially the even-numbered gate signals Ge1, Ge2, . . . to the even-numbered gate lines GLe1, GLe2, . . . , during the odd-numbered frame period (O_FRAME). During the odd-numbered frame period (O_FRAME), each of the even-numbered gate signals Ge1, Ge2, . . . is a negative polarity gate signal, which has the gate-on level corresponding to the second high level HL2 and the gate-off level corresponding to the low level LL.

Then, the negative polarity data signals (−) having a negative polarity with respect to the reference signal VCOM are applied to the pixels connected to the odd-numbered gate lines GLo1, GLo2, . . . , during the even-numbered frame period (E_FRAME). The odd gate circuit 251 generates the odd-numbered gate signals Go1, Go2, . . . using the first gate-on signal VON1 having the second high level HL2 and the first gate-off signal VOFF1 having the low level LL, and sequentially outputs the odd-numbered gate signals Go1, Go2, . . . to the odd-numbered gate lines GLo1, GLo2, . . . , during the even-numbered frame period (E_FRAME). During the even-numbered frame period (E_FRAME), each of the odd-numbered gate signals Go1, Go2, . . . is the negative polarity gate signal, which has the gate-on level corresponding to the second high level HL2 and the gate-off level corresponding to the low level LL.

In such an embodiment, the positive polarity data signals (+) having a positive polarity with respect to a reference signal VCOM are applied to the pixels connected to the even-numbered gate lines GLe1, GLe2, . . . , during the even-numbered frame period (E_FRAME). The even gate circuit 252 generates the even-numbered gate signals Ge1, Ge2, . . . using the second gate-on signal VON2 having the first high level HL1 and the second gate-off signal VOFF2 having the low level LL, and sequentially outputs the even-numbered gate signals Ge1, Ge2, . . . to the even-numbered gate lines GLe1, GLe2, . . . , during the even-numbered frame period (E_FRAME). During the even-numbered frame period (E_FRAME), each of the even-numbered gate signals Ge1, Ge2, . . . is the positive polarity gate signal, which has the gate-on level corresponding to the first high level HL1 and the gate-off level corresponding to the low level LL.

As described above, in an exemplary embodiment, a positive polarity gate signal is applied to the pixels that receive the positive polarity data signal (+), and the positive polarity gate signal has the gate-on level corresponding to the first high level HL1 and the gate-off level corresponding to the low level LL. The negative polarity gate signal is applied to the pixels that receive the negative polarity data signal (−), and the negative polarity gate signal has the gate-on level corresponding to the second high level HL2 and the gate-off level corresponding to the low level LL.

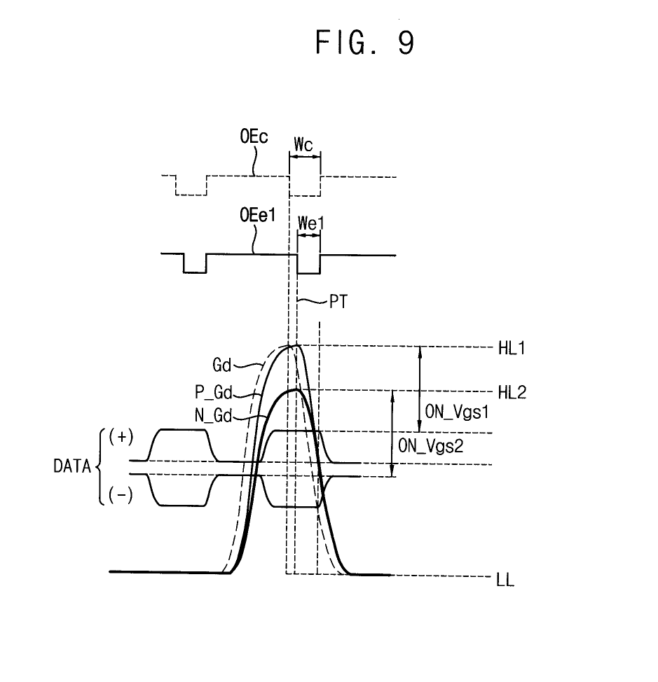

FIG. 9 is a waveform diagram illustrating a data charging ratio according to the gate signal shown in FIG. 8.

Referring to FIGS. 8 and 9, according to an exemplary embodiment, the gate signal includes a positive polarity gate signal P_Gd corresponding to the positive polarity data signal (+) and a negative polarity gate signal N_Gd corresponding to the negative polarity data signal (−). The positive polarity gate signal P_Gd has the gate-on level of the first high level HL1 and the gate-off level of the low level LL. The negative polarity gate signal N_Gd has the gate-on level of the second high level HL2, which is lower than the first high level HL1, and the gate-off level of the low level LL.

A voltage difference between the gate-on and gate-off levels of the positive polarity gate signal P_Gd is different from a voltage difference between the gate-on and gate-off levels of the negative polarity gate signal N_Gd.

According to an exemplary embodiment, the gate/source voltage ON_Vgs 1 of the positive polarity (+) is substantially the same as the gate/source voltage ON_Vgs2 of the negative polarity (−) such that the charging difference between the positive polarity data signal (+) and the negative polarity data signal (−) is substantially reduced.

According to an exemplary embodiment, the gate-on level is dualized as the first high level HL1 and the second high level HL2 such that peak timing PT of the positive polarity gate signal P_Gd and peak timing PT of the negative polarity gate signal N_Gd may be substantially the same as each other, as shown in FIG. 9. Thus, in such an embodiment, the falling timings of the positive polarity gate signal P_Gd and the negative polarity gate signal N_Gd may be controlled by a same output-enable control signal OEe1 having a same control period We1. In such an embodiment, the control period We1 of the output-enable control signal OEe1 may be less than the control period We of the output-enable control signal OEc of the comparative embodiment as shown in FIG. 5B.

In an exemplary embodiment, as shown in FIGS. 8 and 9, only gate-on level of the gate signal is dualized for the positive polarity and the negative polarity such that a difference of the charging ratio is substantially reduced, and the display quality is thereby substantially improved.

In an alternative exemplary embodiment, only gate-off level of the gate signal may be dualized for the positive polarity and the negative polarity such that a difference of the off-leakage current is substantially reduced, and the display quality is thereby substantially improved.

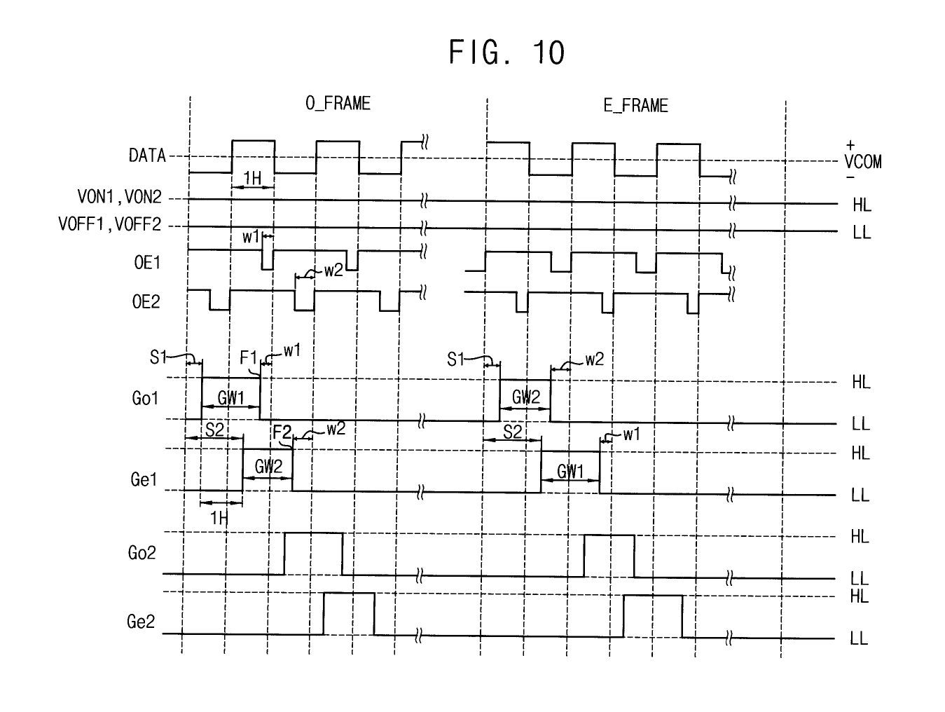

FIG. 10 is signal timing diagram illustrating input and output signals of another alternative exemplary embodiment of a gate driving part shown in FIG. 3.

Referring to FIGS. 3 and 10, according to an exemplary embodiment, an output-enable control signal having a control period is dualized for a positive polarity gate signal and a negative polarity gate signal. By the dualized output-enable control signals, the positive polarity gate signal has a pulse width, which is different from a pulse width of the negative polarity gate signal. In such an embodiment, a charging ratio difference between a positive polarity data signal and a negative polarity data signal is substantially reduced, and the display quality is thereby substantially improved.

In one exemplary embodiment, for example, the gate driving part 250 may include an odd gate circuit 251, which generates a plurality of odd-numbered gate signals Go1, . . . , Gok, and an even gate circuit 252, which generates a plurality of even-numbered gate signals Ge1, . . . , Gek.

The odd gate circuit 251 receives the first gate control signal, the first gate-on signal VON1, the first gate-off signal VOFF1 from the control circuit part 210. The first gate control signal includes a first vertical start signal STV1, a first clock signals CK1 and CKB1, and a first output-enable signal OE1. The first gate-on signal VON1 is a direct current signal having a high level HL, and the first gate-off signal VOFF1 is a direct current signal having a low level LL.

The first vertical start signal STV1 may control a start timing of an operation of the odd gate circuit 251. The first clock signals CK1 and CKB1 may control a rising timing, that is, a start timing of a rising period, during which a level of each of the odd-numbered gate signals Go1, . . . , Gok rises from a low level to a high level. The first output-enable control signal OE1 may control a falling timing, that is, a start timing of a falling period, during which a level of each of the odd-numbered gate signals Go1, . . . , Gok falls from the high level to the low level.

In such an embodiment, the first output-enable control signal OE1 may have a first control period W1 during an odd-numbered frame period (O_FRAME) and have a second control period W2, which is different from the first control period W1, during an even-numbered frame period (E_FRAME). Thus, the odd-numbered gate signals Go1, . . . , Gok may have the falling timing corresponding to the first control period W1 during the odd-numbered frame period (O_FRAME), and have the falling timing corresponding to the second control period W2 during the even-numbered frame period (E_FRAME).

The first gate-on signal VON1 may control a gate-on level of the odd-numbered gate signals Go1, . . . , Gok to the high level HL and the first gate-off signal VOFF1 may control a gate-off level of the odd-numbered gate signals Go1, . . . , Gok to the low level LL.

The even gate circuit 252 receives the second gate control signal, a second gate-on signal VON2 and a second gate-off signal VOFF2 from the control circuit part 210. The second gate control signal includes a second vertical start signal STV2, second clock signals CK2 and CKB2 and second output-enable signal OE2. The second gate-on signal VON2 is the direct current signal having a high level HL, which is substantially the same as the first gate-on signal VON1, and the second gate-off signal VOFF2 is the direct current signal having the low level LL which is substantially the same as the first gate-off signal VOFF 1.

The second vertical start signal STV2 may control a start timing of an operation of the even gate circuit 252. According to an exemplary embodiment, the second vertical start signal STV2 is delayed by one horizontal period (1H) from the first vertical start signal STV1. The second clock signals CK2 and CKB2 may control a rising timing, that is, a start timing of a rising period, during which a level of each of the even-numbered gate signals Ge1, . . . , Gek rises from a low level to a high level. The second output-enable control signal OE2 may control a falling timing, that is, a start timing of a falling period, during which a level of each of the even-numbered gate signals Ge1, . . . , Gek falls from the high level to the low level.

The second output-enable control signal OE2 may have the second control period W2 during an odd-numbered frame period (O_FRAME), and have the first control period W1 during an even-numbered frame period (E_FRAME). Thus, the even-numbered gate signals Ge1, . . . , Gek may have the falling timing corresponding to second control period W2 during the odd-numbered frame period (O_FRAME), and have the falling timing corresponding to the first control period W1 during the even-numbered frame period (E_FRAME).

The second gate-on signal VON2 may control the gate-on level of the even-numbered gate signals Ge1, . . . , Gek to the high level HL and the first gate-off signal VOFF1 may control the gate-off level of the even-numbered gate signals Ge1, . . . , Gek to the low level LL.

Hereinafter, an exemplary embodiment of a method of driving the display panel where the display panel is driven based on the one-dot inversion mode as shown in FIG. 2, will be described in detail. In an exemplary embodiment, the positive polarity data signals (+) having a positive polarity with respect to the reference signal VCOM are applied to the pixels connected to the odd-numbered gate lines GLo1, GLo2, . . . , during the odd-numbered frame period (O_FRAME). During the odd-numbered frame period (O_FRAME), the odd gate circuit 251 generates the odd-numbered gate signals Go1, Go2, . . . using the first gate-on signal VON1 having the high level HL and the first gate-off signal VOFF1 having the low level LL, and respectively controls the falling timing of the odd-numbered gate signals Go1, Go2, . . . based on the first control period W1 of the first output-enable control signal OE1. Thus, each of the odd-numbered gate signals Go1, Go2, . . . has a first pulse width GW1 during the odd-numbered frame period (O_FRAME). The odd-numbered gate signals Go1, Go2, . . . are sequentially applied to the odd-numbered gate lines GLo1, GLo2, . . . , during the odd-numbered frame period (O_FRAME).

In such an embodiment, the negative polarity data signals (−) having a negative polarity with respect to the reference signal VCOM are applied to the pixels connected to the even-numbered gate lines GLe1, GLe2, . . . , during the odd-numbered frame period (O_FRAME). During the odd-numbered frame period (O_FRAME), the even gate circuit 252 generates the even-numbered gate signals Ge1, Ge2, . . . using the second gate-on signal VON2 having the high level HL and the second gate-off signal VOFF2 having the low level LL, and respectively controls the falling timing of the even-numbered gate lines GLe1, GLe2, . . . based on the second control period W2 of the second output-enable control signal OE2. Thus, each of the even-numbered gate lines GLe1, GLe2, . . . has a second pulse width GW2 during the odd-numbered frame period (O_FRAME). The even-numbered gate signals Ge1, Ge2, . . . are sequentially applied to the even-numbered gate lines GLe1, GLe2, . . . , during the odd-numbered frame period (O_FRAME).

Then, the negative polarity data signals (−) are applied to the pixels connected to the odd-numbered gate lines GLo1, GLo2, . . . , during the even-numbered frame period (E_FRAME). During the even-numbered frame period (E_FRAME), the odd gate circuit 251 generates the odd-numbered gate signals Go1, Go2, . . . using the first gate-on signal VON1 having the high level HL and the first gate-off signal VOFF1 having the low level LL, and respectively controls the falling timing of the odd-numbered gate signals Go1, Go2, . . . based on the second control period W2 of the first output-enable control signal OE1. Thus, each of the odd-numbered gate signals Go1, Go2, . . . has the second pulse width GW2 during the even-numbered frame period (E_FRAME). The odd-numbered gate signals Go1, Go2, . . . are sequentially applied to the odd-numbered gate lines GLo1, GLo2, . . . , during the even-numbered frame period (E_FRAME).

In such an embodiment, the positive polarity data signals (+) having a positive polarity with respect to a reference signal VCOM are applied to the pixels connected to the even-numbered gate lines GLe1, GLe2, . . . , during the even-numbered frame period (E_FRAME). During the even-numbered frame period (E_FRAME), the even gate circuit 252 generates the even-numbered gate signals Ge1, Ge2, . . . using the second gate-on signal VON2 having the high level HL and the second gate-off signal VOFF2 having the low level LL and respectively controls the falling timing of the even-numbered gate signals Ge1, Ge2, . . . based on the first control period W1 of the second output-enable control signal OE2. Thus, each of the even-numbered gate signals Ge1, Ge2, . . . has the first pulse width GW1 during the even-numbered frame period (E_FRAME). The even-numbered gate signals Ge1, Ge2, . . . are sequentially applied to the even-numbered gate lines GLe1, GLe2, . . . , during the even-numbered frame period (E_FRAME).

As described above, according to an exemplary embodiment, a positive polarity gate signal is applied to the pixels which receive the positive polarity data signal (+), and the positive polarity gate signal has the first pulse width W1. The negative polarity gate signal is applied to the pixels which receive the negative polarity data signal (−), and the negative polarity gate signal has the second pulse width W2 less than the first pulse width W1. In such an embodiment, the gate-on level and the gate-off level of the positive polarity gate signal are substantially the same as the gate-on level and the gate-off level of the negative polarity gate signal.

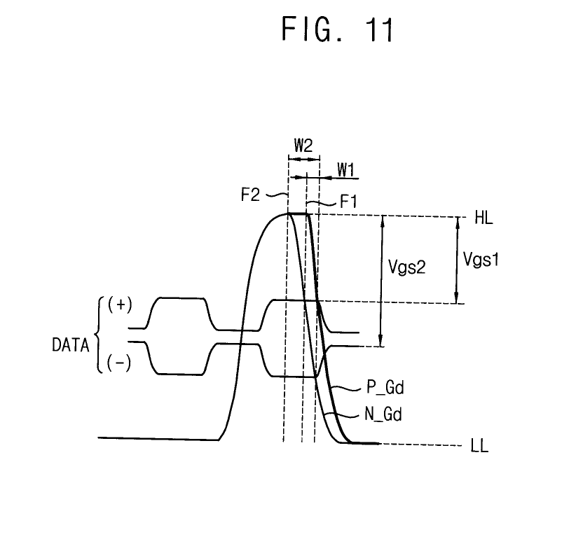

FIG. 11 is a waveform diagram illustrating a data charging ratio according to the gate signal shown in FIG. 10.

Referring to FIGS. 10 and 11, according to an exemplary embodiment, a gate driving part generates a positive polarity gate signal P_Gd and a negative polarity gate signal N_Gd such that a charging ratio difference between a positive polarity data signal and a negative polarity data signal by the RC time delay is substantially reduced.

A first falling timing F1 of the positive polarity gate signal P_Gd applied to a pixel row is determined to decrease a mixing with a positive polarity signal (+) applied to a next pixel row and to increase the charging ratio of a positive polarity signal (+) applied to the pixel row. The first falling timing F1 corresponds to the first control period W1 of the output-enable control signal. The positive polarity gate signal P_Gd has a gate-on level of the high level HL and a gate-off level of the low level LL.

A second falling timing F2 of the negative polarity gate signal N_Gd applied to a pixel row is determined to decrease a mixing with a negative polarity data signal (−) applied to a next pixel row and to increase the charging ratio of a negative polarity data signal (−) to the pixel row. The second falling timing F2 corresponds to a second control period W2 of the output-enable control signal. In such an embodiment, the second control period W2 may be longer than the first control period W1. The negative polarity gate signal N_Gd has a gate-on level of the high level HL and a gate-off level of the low level LL.

The gate-on level and the gate-off level of the positive polarity gate signal are the same as the gate-on level and the gate-off level of the negative polarity gate signal such that a gate/source voltage Vgs1 of the positive polarity (+) may be less than a gate/source voltage Vgs2 of the negative polarity (−), as shown in FIG. 11. However, in such an embodiment, the first falling timing F1 of the positive polarity gate signal in the horizontal period is relatively later than the second falling timing F2 of the negative polarity gate signal in the horizontal period such that the charging ratio of the positive polarity data signal (+) is substantially increased.

Therefore, in such an embodiment, a charging ratio difference between a positive polarity data signal and a negative polarity data signal are substantially reduced, and the display quality is thereby substantially improved.

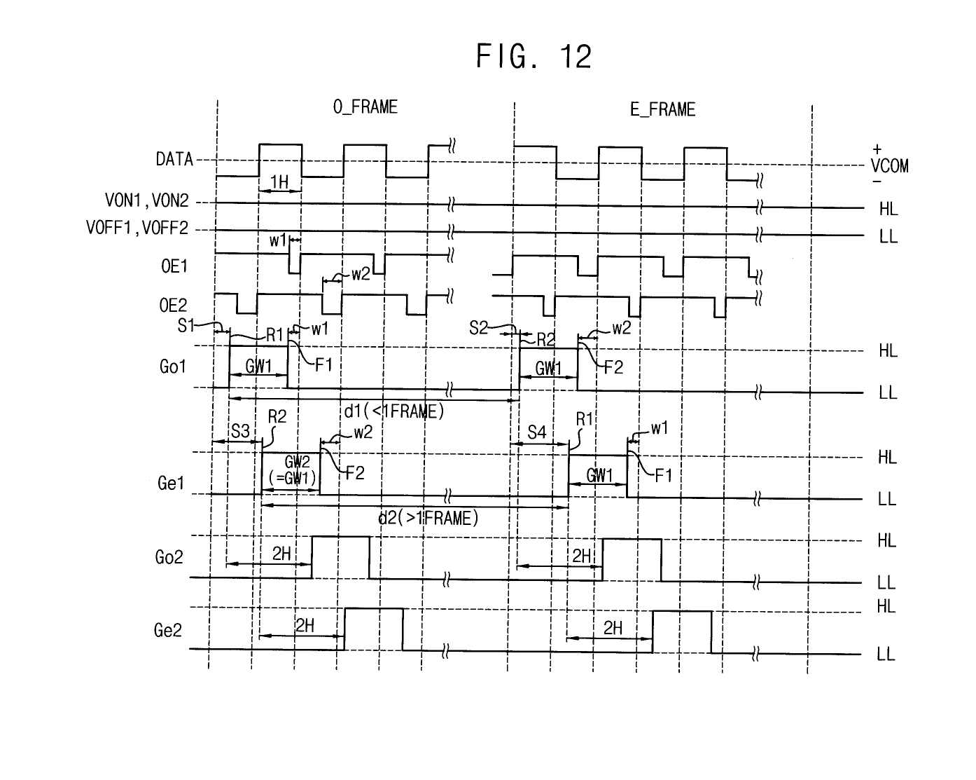

FIG. 12 is signal timing diagram illustrating input and output signals of another alternative exemplary embodiment of a gate driving part shown in FIG. 3.

Referring to FIGS. 3 and 12, according to an exemplary embodiment, the first falling timing F1 of the positive polarity gate signal in the horizontal period is relatively later than the second falling timing F2 of the negative polarity gate signal in the horizontal period such that the charging ratio of the positive polarity data signal (+) is substantially increased, as in the exemplary embodiment shown in FIGS. 10 and 11. In an exemplary embodiment, as shown in FIG. 12, a rising timing of the negative polarity gate signal in the horizontal period is relatively earlier than a rising timing of the positive polarity gate signal in the horizontal period such that a pulse width of the negative polarity gate signal is substantially the same as a pulse width of the positive polarity gate signal. Thus, in such an embodiment, the charging ratio of the negative polarity data signal (−) is substantially increased.

In one exemplary embodiment, for example, the gate driving part 250 may include an odd gate circuit 251, which generates a plurality of odd-numbered gate signals Go1, . . . , Gok, and an even gate circuit 252, which generates a plurality of even-numbered gate signals Ge1, . . . , Gek.

The odd gate circuit 251 receives the first gate control signal, the first gate-on signal VON1, the first gate-off signal VOFF1 from the control circuit part 210. The first gate control signal includes a first vertical start signal STV1, a first clock signals CK1 and CKB1, and a first output-enable signal OE1. The first gate-on signal VON1 is a direct current signal having a high level HL, and the first gate-off signal VOFF1 VON1 is a direct current signal having a low level LL.

The first vertical start signal STV1 may control a start timing of an operation of the odd gate circuit 251. According to an exemplary embodiment, the first vertical start signal STV1 controls a first start timing S1, which is a start timing of the operation of the odd gate circuit 251 during an odd-numbered frame period (O_FRAME), and controls a second start timing S2, which is a start timing of the operation of the odd gate circuit 251 during an even-numbered frame period (E_FRAME). The second start timing S2 has a delay from the first start timing S1, and the delay may be shorter than a frame period. The first vertical start signal STV1 may be repeated every two frame periods.

The first clock signals CK1 and CKB1 may control a rising timing, that is, a start timing of a rising period, during which a level of each of the odd-numbered gate signals Go1, . . . , Gok rises from a low level to a high level. According to an exemplary embodiment, in response to the first vertical start signal STV1, the odd gate circuit 251 generates the odd-numbered gate signals Go1, . . . , Gok having a first rising timing R1 during the odd-numbered frame period (O_FRAME), and generates the odd-numbered gate signals Go1, . . . , Gok having a second rising timing R2 during even-numbered frame period (E_FRAME). In such an embodiment, the second rising timing R2 in the horizontal period is relatively earlier than the first rising timing R1 in the horizontal period.

The first output-enable control signal OE1 may control a falling timing, that is, a start timing of a falling period, during which a level of each of the odd-numbered gate signals Go1, . . . , Gok falls from the high level to the low level. According to an exemplary embodiment, the first output-enable control signal OE1 has a first control period W1 during the odd-numbered frame period (O_FRAME), and has a second control period W2 different from the first control period W1 during the even-numbered frame period (E_FRAME). Thus, in such an embodiment, the odd-numbered gate signals Go1, . . . , Gok has a first falling timing F1 corresponding to the first control period W1 during the odd-numbered frame period (O_FRAME), and has a second falling timing F2 corresponding to the second control period W2 during the even-numbered frame period (E_FRAME).

The first gate-on signal VON1 may control a gate-on level of the odd-numbered gate signals Go1, . . . , Gok to the high level HL, and the first gate-off signal VOFF1 may control a gate-off level of the odd-numbered gate signals Go1, . . . , Gok to the low level LL.

The even gate circuit 252 receives the second gate control signal, a second gate-on signal VON2 and a second gate-off signal VOFF2 from the control circuit part 210. The second gate control signal includes a second vertical start signal STV2, second clock signals CK2 and CKB2 and second output-enable signal OE2. The second gate-on signal VON2 is the direct current signal having a high level HL, which is substantially the same as the high level HL of the first gate-on signal VON1, and the second gate-off signal VOFF2 is the direct current signal having the low level LL, which is substantially the same as the low level LL of the first gate-off signal VOFF1.

The second vertical start signal STV2 may control a start timing of an operation of the even gate circuit 252. According to an exemplary embodiment, the second vertical start signal STV2 controls a third start timing S3, which is a start timing of the operation of the even gate circuit 252 during an odd-numbered frame period (O_FRAME) and controls a fourth start timing S4, which is a start timing of the operation of the even gate circuit 252 during an even-numbered frame period (E_FRAME). The fourth start timing S4 has a delay from the third start timing S3, and the delay may be longer than a frame period. The second vertical start signal STV2 may be repeated every two frame periods.

The second clock signals CK2 and CKB2 may control a rising timing, that is, a start timing of a rising period, during which a level of each of the even-numbered gate signals Ge1, . . . , Gek rises from a low level to a high level. According to an exemplary embodiment, in response to the second vertical start signal STV2, the even gate circuit 252 generates the even-numbered gate signals Ge1, . . . , Gek having the second rising timing R2 during the odd-numbered frame period (O_FRAME), and generates the even-numbered gate signals Ge1, . . . , Gek having the first rising timing R1 during even-numbered frame period (E_FRAME). In such an embodiment, the second rising timing R2 in the horizontal period is relatively earlier than the first rising timing R1 in the horizontal period.

The second output-enable control signal OE2 may control a falling timing, that is, a start timing of a falling period, during which a level of each of the even-numbered gate signals Ge1, . . . , Gek falls from the high level to the low level. According to an exemplary embodiment, the second output-enable control signal OE2 has the second control period W2 during the odd-numbered frame period (O_FRAME), and has the first control period W1 during an even-numbered frame period (E_FRAME). Thus, in such an embodiment, the even-numbered gate signals Ge1, . . . , Gek has the second falling timing F2 corresponding to the second control period W2 during the odd-numbered frame period (O_FRAME), and has the first falling timing F1 corresponding to the first control period W1 during the even-numbered frame period (E_FRAME).

The second gate-on signal VON2 may control a gate-on level of the even-numbered gate signals Ge1, . . . , Gek to the high level HL, and the second gate-off signal VOFF2 may control a gate-off level of the even-numbered gate signals Ge1, . . . , Gek to the low level LL.

Hereinafter, an exemplary embodiment a method of driving the display panel, where the display panel is driven based on the one-dot inversion mode as shown in FIG. 2, will be described in detail. In such an embodiment, the positive polarity data signals (+) having a positive polarity with respect to the reference signal VCOM are applied to the pixels connected to the odd-numbered gate lines GLo1, GLo2, . . . , during the odd-numbered frame period (O_FRAME). The odd gate circuit 251 generates the odd-numbered gate signals Go1, Go2, . . . using the first gate-on signal VON1 having the high level HL and the first gate-off signal VOFF1 having the low level LL, during the odd-numbered frame period (O_FRAME). The odd-numbered gate signals Go1, Go2, . . . have a first rising timing R1 based on the first vertical start signal STV1, and have a first falling timing F1 based on the first control period W1 of the first output-enable control signal OE1, during the odd-numbered frame period (O_FRAME). Each of the odd-numbered gate signals Go1, Go2, . . . has a first pulse width GW1, and sequentially applied to the odd-numbered gate lines GLo1, GLo2, . . . with an interval of two horizontal periods 2H, during the odd-numbered frame period (O_FRAME).

In such an embodiment, the negative polarity data signals (−) having a negative polarity with respect to the reference signal VCOM are applied to the pixels connected to the even-numbered gate lines GLe1, GLe2, . . . , during an odd-numbered frame period (O_FRAME). During an odd-numbered frame period (O_FRAME), the even gate circuit 252 generates the even-numbered gate signals Ge1, Ge2, . . . using the second gate-on signal VON2 having the high level HL and the second gate-off signal VOFF2 having the low level LL. The even-numbered gate signals Ge1, Ge2, . . . have a second rising timing R2 based on the second vertical start signal STV2, and have a second falling timing F2 based on the second control period W2 of the second output-enable control signal OE2. Each of the even-numbered gate lines GLe1, GLe2, . . . has a second pulse width GW2 which is substantially the same as the first pulse width GW1, and are sequentially applied to the even-numbered gate lines GLe1, GLe2, . . . with an interval of two horizontal periods 2H.

Then, the negative polarity data signals (−) are applied to the pixels connected to the odd-numbered gate lines GLo1, GLo2, . . . , during the even-numbered frame period (E_FRAME). The odd gate circuit 251 generates the odd-numbered gate signals Go1, Go2, . . . using the first gate-on signal VON1 having the high level HL and the first gate-off signal VOFF1 having the low level LL, during the even-numbered frame period (E_FRAME). The odd-numbered gate signals Go1, Go2, . . . have the second first rising timing R2 based on the first vertical start signal STV1 and have a second falling timing F2 based on the second control period W2 of the first output-enable control signal OE1, during the even-numbered frame period (E_FRAME). Each of the odd-numbered gate signals Go1, Go2, . . . has the first pulse width GW1 and sequentially applied to the odd-numbered gate lines GLo1, GLo2, . . . with an interval of two horizontal periods 2H, during the even-numbered frame period (E_FRAME).

In such an embodiment, the positive polarity data signals (+) having a positive polarity with respect to a reference signal VCOM are applied to the pixels connected to the even-numbered gate lines GLe1, GLe2, . . . during the even-numbered frame period (E_FRAME). The even gate circuit 252 generates the even-numbered gate signals Ge1, Ge2, . . . using the second gate-on signal VON2 having the high level HL and the second gate-off signal VOFF2 having the low level LL, during the even-numbered frame period (E_FRAME). The even-numbered gate signals Ge1, Ge2, . . . have the first rising timing R1 based on the second vertical start signal STV2 and have the first falling timing F1 based on the first control period W1 of the second output-enable control signal OE2, during the even-numbered frame period (E_FRAME). Each of the even-numbered gate lines GLe1, GLe2, . . . has the second pulse width GW2 being the same as the first pulse width GW1, and sequentially applied to the even-numbered gate lines GLe1, GLe2, . . . with an interval of two horizontal periods 2H, during the even-numbered frame period (E_FRAME).

As described above, according to an exemplary embodiment, the falling timings of the positive and negative polarities gate signals are controlled independently of or differently from each other using the output-enable control signal such that a charging ratio difference between a positive polarity data signal and a negative polarity data signal are substantially reduced. In such an embodiment, the pulse widths of the positive and negative polarities gate signals may be controlled to be substantially the same as each other using the vertical start signal such that the charging ratio of the negative polarity data signal are substantially increased.

According to exemplary embodiments of the invention, the gate signal is dualized to include the positive polarity gate signal corresponding to the positive polarity data signal and the negative polarity gate signal corresponding to the negative polarity data signal. Therefore, in such embodiments, a charging ratio difference between a positive polarity data signal and a negative polarity data signal by the RC time delay is substantially reduced, and the display quality is thereby substantially improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel, the method comprising:
providing a switching element of a pixel of the display panel with a first polarity gate signal through a gate line connected to the switching element when the switching element receives a first polarity data signal having a first polarity with respect to a reference signal through a data line connected to the switching element; and
providing the switching element with a second polarity gate signal through the gate line when the switching element receives a second polarity data signal having a second polarity with respect to the reference signal through the data line.

2. The method of claim 1, wherein
a falling timing of the first polarity gate signal in a horizontal period is substantially the same as a falling timing of the second polarity gate signal in the horizontal period,
the falling timing of the first polarity gate signal is a start timing of a falling period, during which a level of the first polarity gate signal falls from a high level to a low level, and
the falling timing of the second polarity gate signal is a start timing of a falling period, during which a level of the second polarity gate signal falls from a high level to a low level.

3. The method of claim 2, wherein
the first polarity gate signal has a first gate-on level and a first gate-off level, and
the second polarity gate signal has a second gate-on level lower than the first gate-on level and a second gate-off level lower than the first gate-off level.

4. The method of claim 2, wherein
one of a gate-on level and a gate-off level of the first polarity gate signal is different from one of a gate-on level and a gate-off level of the second polarity gate signal.

5. The method of claim 1, wherein
a falling timing of the first polarity gate signal is different from a falling timing of the second polarity gate signal in a horizontal period,
the falling timing of the first polarity gate signal is a start timing of a falling period, during which a level of the first polarity gate signal falls from a high level to a low level, and
the falling timing of the second polarity gate signal is a start timing of a falling period, during which a level of the second polarity gate signal falls from a high level to a low level.

6. The method of claim 5, wherein
a gate-on level and a gate-off level of the first polarity gate signal are substantially the same as a gate-on level and a gate-off level of the second polarity gate signal, respectively.

7. The method of claim 6, wherein
the first polarity gate has a first pulse width, and
the second polarity gate signal has a second pulse width different from the first pulse width.

8. The method of claim 6, wherein
the first polarity gate has a pulse width, which is substantially the same as a pulse width of the second polarity gate signal.

9. A display apparatus comprising:
a display panel comprising a plurality of data lines, a plurality of gate lines and a plurality of pixels, wherein each of the pixels comprises a switching element connected to a corresponding data line of the data lines and a corresponding gate line of the gate lines;
a data driving part which provides the display panel with a first polarity data signal having a first polarity with respect to a reference signal and a second polarity data signal having a second polarity with respect to the reference signal; and
a gate driving part which provides the switching element with a first polarity gate signal when the switching element receives the first polarity data signal, and provides the switching element with a second polarity gate signal when the switching element receives the second polarity data signal.

10. The display apparatus of claim 9, wherein
a falling timing of the first polarity gate signal in a horizontal period is substantially the same as a falling timing of the second polarity gate signal in the horizontal period,
the falling timing of the first polarity gate signal is a start timing of a falling period, during which a level of the first polarity gate signal falls from a high level to a low level, and
the falling timing of the second polarity gate signal is a start timing of a falling period, during which a level of the second polarity gate signal falls from a high level to a low level.

11. The display apparatus of claim 10, wherein
the first polarity gate signal has a first gate-on level and a first gate-off level, and
the second polarity gate signal has a second gate-on level lower than the first gate-on level and a second gate-off level lower than the first gate-off level.

12. The display apparatus of claim 10, wherein
one of a gate-on level and a gate-off level of the first polarity gate signal is different from one of a gate-on level and a gate-off level of the second polarity gate signal.

13. The display apparatus of claim 9, wherein
a falling timing of the first polarity gate signal in a horizontal period is different from a falling timing of the second polarity gate signal in the horizontal period,
the falling timing of the first polarity gate signal is a start timing of a falling period, during which a level of the first polarity gate signal falls from a high level to a low level, and
the falling timing of the second polarity gate signal is a start timing of a falling period, during which a level of the second polarity gate signal falls from a high level to a low level.

14. The display apparatus of claim 13, wherein
the falling timing of the first polarity gate signal in the horizontal period is later than the falling timing of the second polarity gate signal in the horizontal period.

15. The display apparatus of claim 13, wherein a gate-on level and a gate-off level of the first polarity gate signal are substantially the same as a gate-on level and a gate-off level of the second polarity gate signal, respectively.

16. The display apparatus of claim 15, wherein
the first polarity gate has a pulse width different from a pulse width of the second polarity gate signal.

17. The display apparatus of claim 15, wherein
the first polarity gate has a pulse width substantially the same as a pulse width of the second polarity gate signal.

18. The display apparatus of claim 9, wherein
the pixels of the display panel are arranged substantially in a matrix form including a plurality of pixel columns in a first direction and a plurality of pixel rows in a second direction crossing the first direction,
a gate line of the gate lines is alternately connected to the pixels in two adjacent pixel rows,
a data line of the data lines is connected to the pixels in a same pixel column,
the first polarity gate signal is applied to an odd-numbered gate line of the gate lines, and
the second polarity gate is applied to an even-numbered gate line of the gate lines.

19. The display apparatus of claim 9, wherein
each of the pixels comprises a first sub-pixel and a second sub-pixel,
the first sub-pixel comprises a first switching element connected to a first data line of the data lines, which receives the first polarity data signal, and a first gate line of the gate lines, which receives the first polarity gate signal, and
the second sub-pixel comprises a second switching element connected to a second data line of the data lines, which receives the second polarity data signal, and a second gate line of the gate lines, which receives the second polarity gate signal.

20. The display apparatus of claim 9, wherein
the pixels of the display panel are arranged substantially in a matrix form including a plurality of pixel columns in a first direction and a plurality of pixel rows in a second direction crossing the first direction,
a gate line of the gate liens is alternately connected to the pixels in two adjacent pixel rows,
the pixels in a same pixel column are alternately connected to two adjacent data lines,
the first polarity gate signal is applied to an odd-numbered gate line of the gate lines, and
the second polarity gate is applied to an even-numbered gate line of the gate lines.
